(19) United States
(12) Patent Application Publication
(10) Pub. No.: US 2025/0124254 A1
(43) Pub. Date: Apr. 17, 2025

(54) COMPUTATION METHOD FOR BINARY NEURAL NETWORK AND COMPUTING DEVICE FOR EXECUTING THE SAME

(71) Applicant: University-Industry Cooperation Group of Kyung Hee University, Gyeonggi-do (KR)

(72) Inventors: CHOONG SEON HONG, Gyeonggi-do (KR); LOK WON KIM, Gyeonggi-do (KR); QUANG HIEU VO, Gyeonggi-do (KR); HYEON SU KIM, Gyeonggi-do (KR)

(21) Appl. No.: 18/913,112

(22) Filed: Oct. 11, 2024

(30) Foreign Application Priority Data
Oct. 13, 2023 (KR) 10-2023-0136760

(51) Int. Cl. G06N 3/042; G06N 3/0464

(52) U.S. Cl. CPC G06N 3/042; G06N 3/0464

(57) ABSTRACT

A computation method for the binary neural network is performed on a computing device that includes one or more processors and a memory storing one or more programs executed by the one or more processors, and includes generating a fully connected graph based on output channels of a convolutional layer of a binary neural network, extracting a minimum spanning tree from the fully connected graph, and re-arranging an order of computations between respective output channels based on the minimum spanning tree.

### CROSS REFERENCE TO RELATED APPLICATION AND CLAIM OF PRIORITY

This application claims the benefit under 35 USC § 119 (a) of Korean Patent Application No. 10-2023-0136760, filed on Oct. 13, 2023, in the Korean Intellectual Property Office, the entire disclosure of which is incorporated herein by reference for all purposes.

### BACKGROUND

### 1. Field

Embodiments of the present disclosure relate a computation technique for a binary neural network.

### 2. Description of Related Art

A deep neural network (DNN) has been widely applied in many artificial intelligence applications such as computer vision and speech recognition. However, there are many limitations when applying the DNN to embedded systems such as mobile devices and other resource-constrained platforms, due to computational complexity and the cost of enormous capacity burden, which is problematic.

Meanwhile, a binary neural network (BNN) is a special form of quantization method that converts weights and activations of a neural network into 1-bit values, and replaces multiplication and accumulation operations with simple logical operations such as exclusive NOR (XNOR) operation and popcount operation, thereby saving power and resources. However, as an artificial neural network becomes deeper and wider to meet practical requirements while reducing accuracy degradation, the computational burden still remains a challenge even for the BNN.

Examples of the related art include Korean Laid-Open Patent Publication No. 10-2022-0090078 (2022.06.29).

### SUMMARY

An embodiment of the present disclosure is intended to provide a computation method for a binary neural network, which can reduce computational costs while increasing the computational speed of the binary neural network, and a computing device for performing the same.

According to an aspect of the present disclosure, there is provided a computation method for a binary neural network method performed on a computing device that includes one or more processors and a memory storing one or more programs executed by the one or more processors, the computation method including generating a fully connected graph based on output channels of a convolutional layer of a binary neural network, extracting a minimum spanning tree from the fully connected graph, and re-arranging an order of computations between respective output channels based on the minimum spanning tree.

The fully connected graph may be generated based on a distance between the output channels.

The output channel may include a list of weights consisting of 0 or 1, and the distance between the output channels may be calculated through a Hamming distance.

The fully connected graph may be generated by using each output channel as a node and the Hamming distance between respective output channels as an edge.

The re-arranging of the order of computations may include performing the computation on an output channel corresponding to a highest node in the minimum spanning tree.

The re-arranging of the order of computations may further include performing the computation along lower nodes having shorter Hamming distances from the highest node of the minimum spanning tree.

The computing device may use the following equation to compute a j-th output channel from an i-th output channel,

$${Y}_{j} = 2 ( {P}_{i} - {d}_{i j} + 2 {P}_{ij} ) - {C}_{i n} \times M \times M \qquad [ Equation ]$$

where Pᵢ is a Popcount operation of the i-th output channel,
dᵢⱼ is a Hamming distance between the i-th output channel and the j-th output channel,
Pᵢⱼ is a sum of XNOR operations between the i-th output channel and the j-th output channel,
Cᵢₙ is an input channel of the binary neural network, and
M is a kernel size.

The computation method for the binary neural network may further include clustering weights of each output channel of the convolutional layer of the binary neural network, randomly selecting a center from each cluster in which the weights are clustered, and training the binary neural network so that the distance between the center of each cluster and each weight belonging to the cluster is minimized.

According to another aspect of the present disclosure, there is provided a computing device that includes one or more processors, a memory, and one or more programs, in which the one or more programs are stored in the memory and configured to be executed by the one or more processors, the one or more programs include an instruction for generating a fully connected graph based on output channels of a convolutional layer of a binary neural network, an instruction for extracting a minimum spanning tree from the fully connected graph, and an instruction for re-arranging an order of computations between respective output channels based on the minimum spanning tree.

### BRIEF DESCRIPTION OF THE DRAWINGS

FIG. 1 is a block diagram showing a computing environment including a computing device suitable for use in exemplary embodiments.

FIG. 2 is a flowchart showing a method for computing a binary neural network according to an embodiment of the present disclosure.

FIG. 3 is a diagram showing a state of re-arranging an order of computations in a convolution layer of a binary neural network according to an embodiment of the present disclosure.

FIGS. 4A and 4B are a diagram showing a comparison between the computation for the conventional binary neural network and the computation for the binary neural network operation according to an embodiment of the present disclosure.

### DETAILED DESCRIPTION

Hereinafter, a specific embodiment of the present disclosure will be described with reference to the drawings. The following detailed description is provided to aid in a comprehensive understanding of the methods, apparatus and/or systems described herein. However, this is illustrative only, and the present disclosure is not limited thereto.

In describing the embodiments of the present disclosure, when it is determined that a detailed description of related known technologies may unnecessarily obscure the subject matter of the present disclosure, a detailed description thereof will be omitted. Additionally, terms to be described later are terms defined in consideration of functions in the present disclosure, which may vary according to the intention or custom of users or workers. Therefore, the definition should be made based on the contents throughout this specification. The terms used in the detailed description are only for describing embodiments of the present disclosure, and should not be limiting. Unless explicitly used otherwise, expressions in the singular form include the meaning of the plural form. In this description, expressions such as “comprising” or “including” are intended to refer to certain features, numbers, steps, actions, elements, some or combination thereof, and it is not to be construed to exclude the presence or possibility of one or more other features, numbers, steps, actions, elements, some or combinations thereof, other than those described.

In addition, the terms “first”, “second”, etc. may be used to describe various components, but the components should not be limited by the terms. The terms may be used to distinguish one component from another. For example, without departing from the scope of the present disclosure, a first component may be referred to as a second component, and similarly, a second component may also be referred to as a first component.

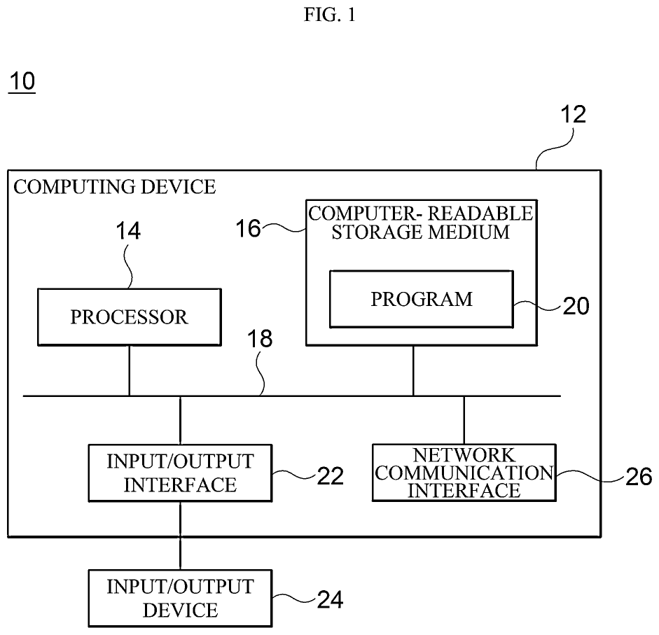

FIG. 1 is a block diagram for describing a computing environment including a computing device suitable for use in exemplary embodiments. In the shown embodiment, respective components may have different functions and capabilities other than those described below, and may include additional components in addition to those described below.

A shown computing environment 10 includes a computing device 12. In one embodiment, the computing device 12 may be a device for performing the computation for a binary neural network (BNN). The computing device 12 may be a device for increasing the computational speed in the BNN.

The computing device 12 includes at least one processor 14, a computer-readable storage medium 16, and a communication bus 18. The processor 14 may cause the computing device 12 to operate according to the exemplary embodiment described above. For example, the processor 14 may execute one or more programs stored on the computer-readable storage medium 16. The one or more programs may include one or more computer-executable instructions, which, when executed by the processor 14, may be configured so that the computing device 12 performs operations according to the exemplary embodiment.

The computer-readable storage medium 16 is configured so that the computer-executable instruction or program code, program data, and/or other suitable forms of information are stored. A program 20 stored in the computer-readable storage medium 16 includes a set of instructions executable by the processor 14. In an embodiment, the computer-readable storage medium 16 may be a memory (volatile memory such as a random access memory, non-volatile memory, or any suitable combination thereof), one or more magnetic disk storage devices, optical disk storage devices, flash memory devices, other types of storage media that are accessible by the computing device 12 and capable of storing desired information, or any suitable combination thereof.

The communication bus 18 interconnects various other components of the computing device 12, including the processor 14 and the computer-readable storage medium 16.

The computing device 12 may also include one or more input/output interfaces 22 that provide an interface for one or more input/output devices 24, and one or more network communication interfaces 26. The input/output interface 22 and the network communication interface 26 are connected to the communication bus 18. The input/output device 24 may be connected to other components of the computing device 12 through the input/output interface 22. The exemplary input/output device 24 may include a pointing device (such as a mouse or trackpad), a keyboard, a touch input device (such as a touch pad or touch screen), a speech or sound input device, input devices such as various types of sensor devices and/or photographing devices, and/or output devices such as a display device, a printer, a speaker, and/or a network card. The exemplary input/output device 24 may be included inside the computing device 12 as a component configuring the computing device 12, or may be connected to the computing device 12 as a separate device distinct from the computing device 12.

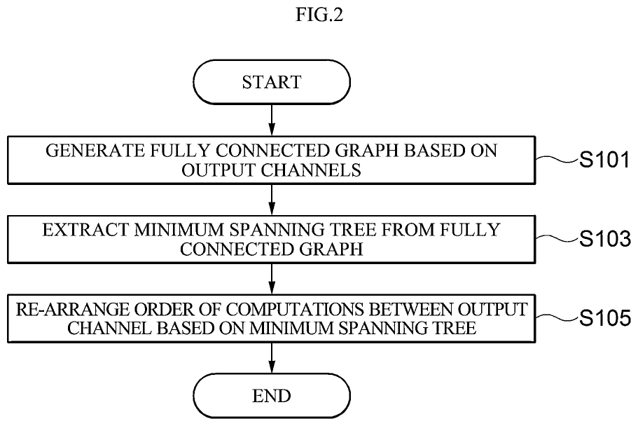

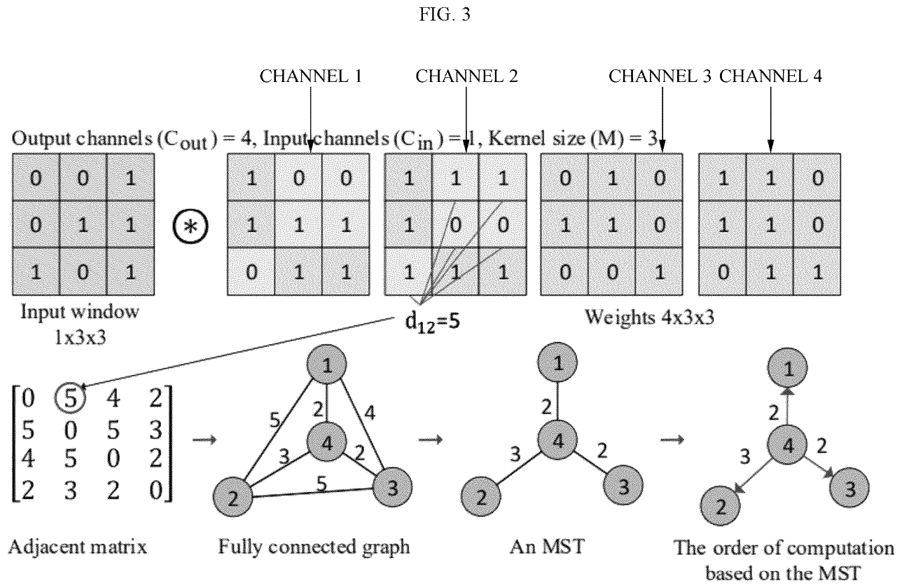

FIG. 2 is a flowchart showing a computation method for a binary neural network method according to an embodiment of the present disclosure. Although the method is described as being divided into a plurality of steps in the shown flowchart, at least some of the steps may be performed in a different order, performed together with other steps, omitted, performed by dividing into sub-steps, or performed by being added with one or more steps (not shown). In addition, FIG. 3 is a diagram showing a state of re-arranging the order of computations in a convolution layer of the binary neural network according to an embodiment of the present disclosure. In FIG. 3, the case where the number of output channels of a binary convolution layer are 4 and a kernel size is 3×3 is shown.

Referring to FIG. 2 and FIG. 3, the computing device 12 may generate a fully connected graph based on output channels of the convolution layer of the binary neural network (S 101). The computing device 12 may generate the fully connected graph based on a distance between the output channels (channel 1, channel 2, channel 3, and channel 4) of the convolution layer in the binary neural network. Each output channel may consist of a list of weights, the number of which corresponds to a kernel size (i.e., 3×3=9). In this case, the weight may consist of 0 or 1.

Specifically, the computing device 12 may generate an adjacency matrix based on the distance between the output channels of the convolution layer. In one embodiment, the distance between the output channels may be calculated through a Hamming distance. The Hamming distance represents the number of mismatches in corresponding bit values between binary codes having the same number of bits.

For example, in FIG. 3, the Hamming distance between output channel 1 and output channel 2 is 5 (d₁₂=5). That is, the number of mismatches in bit values between output channel 1 and output channel 2 is 5. Output channel 1 has a bit value of {100111011}, and output channel 2 has a bit value of {111100111}, but the values do not match in the second, third, fifth, sixth, and seventh bits, and thus the Hamming distance between output channel 1 and output channel 2 is 5. In addition, the Hamming distance between output channel 1 and output channel 3 is 4 (d₁₃=4). In addition, the Hamming distance between output channel 1 and output channel 4 is 2 (d₁₄=2). In this way, the computing device 12 may calculate the Hamming distance between respective output channels and generate a 4×4 adjacency matrix with the Hamming distance value between respective output channels as a matrix element.

Here, the computing device 12 may generate a fully connected graph based on the adjacency matrix according to the distance between the output channels. The computing device 12 may generate the fully connected graph in which each output channel is completely connected by using each output channel as a node and the distance between respective output channels as an edge.

Next, the computing device 12 may extract a minimum spanning tree from the fully connected graph (S 103). Here, the minimum spanning tree refers to a spanning tree in which the sum of the weights connecting all nodes is minimum in an undirected graph in which each edge has a weight (in this case, a Hamming distance).

The computing device 12 may extract the minimum spanning tree from the fully connected graph using a preset algorithm for extracting a minimum spanning tree (e.g., Kruskal algorithm, Prim algorithm, etc.) from a graph. In FIG. 3, a state in which a minimum spanning tree, in which the sum of weights (i.e., Hamming distances) (2+3+2=8) connecting all nodes centered on node 4 (i.e., channel 4) is minimum, is extracted is shown.

Next, the computing device 12 may re-arrange an order of computations between respective output channels based on the minimum spanning tree of the fully connected graph (S 105).

Specifically, the computing device 12 may first perform the computation on an output channel corresponding to the highest node (root node) in the minimum spanning tree. Here, the highest node may be a node that has the largest number of connections to adjacent nodes in the minimum spanning tree. In FIG. 3, node 4 may be the highest node.

The computing device 12 may perform the computation along lower nodes having shorter Hamming distances from the highest node of the minimum spanning tree. In this case, when the Hamming distance between the highest node and the lower nodes is the same, the computation may be performed simultaneously on respective lower nodes. Referring to FIG. 3, after the computation is performed on node 4 (output channel 4), which is the highest node, the computation is performed simultaneously on node 1 (output channel 1) and node 3 (output channel 3) having shorter Hamming distances from node 4, and the computation is performed last on node 2 (output channel 2) having the longest Hamming distance from node 4.

The computing device 12 may use the following Equation 1 to compute a j-th output channel from an i-th output channel,

$${Y}_{j} = 2 ( {P}_{i} - {d}_{i j} + 2 {P}_{i j} ) - {C}_{i n} \times M \times M \qquad [ Equation 1 ]$$

where Pᵢ is a Popcount operation of the i-th output channel,
dᵢⱼ is a Hamming distance between the i-th output channel and the j-th output channel, Pᵢⱼ is a sum of XNOR operations between the i-th output channel and the j-th output channel,
Cᵢₙ is an input channel of the binary neural network, and
M is a kernel size.

According to the disclosed embodiment, by constructing a fully connected graph for each output channel of the convolutional layer of the binary neural network, extracting a minimum spanning tree from the fully connected graph, and re-arranging an order of computations between respective output channels based on the minimum spanning tree, the computational speed in the binary neural network can be increased while reducing the computational cost.

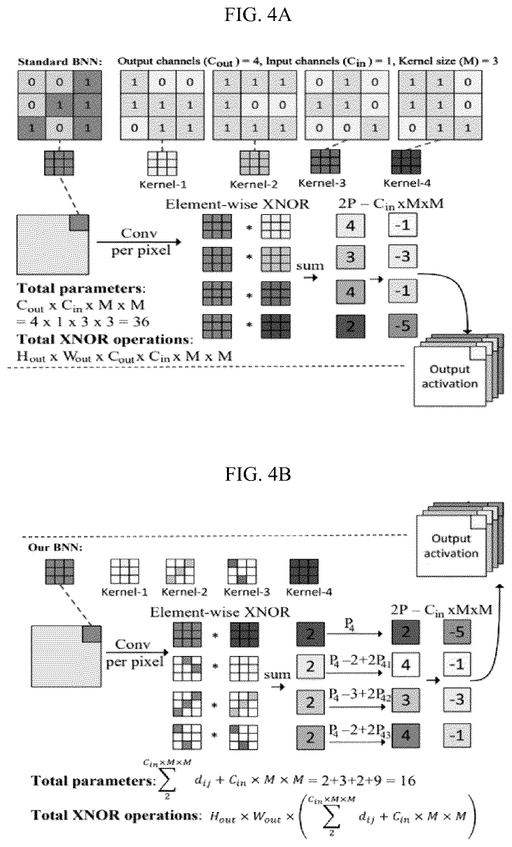

FIGS. 4A and 4B are a diagram showing a comparison between the computation for the conventional binary neural network and the computation for the binary neural network operation according to an embodiment of the present disclosure. FIG. 4A is a diagram the computation for the conventional binary neural network and FIG. 4B is a diagram showing the computation for the binary neural network operation according to an embodiment of the present disclosure.

Referring to FIGS. 4A and 4B, the computation for the binary neural network (Our BNN) according to an embodiment of the present disclosure provides an optimal order of computations that minimizes the number of XNOR operations and the total number of parameters by using a minimum spanning tree (MST) instead of performing all Cᵢₙ×M×M XNOR operations for each layer.

That is, in the case of the computation for the conventional binary neural network in FIGS. 4A and 4B, the total number of parameters is Cₒᵤₜ×Cᵢₙ×M×M=4×1×3×3=36. In contrast, the total number of parameters of the computation for the binary neural network according to the present embodiment is reduced to Σ₂^{C}^{ᵢₙ}^{×M×M} dᵢⱼ+Cᵢₙ×M×M=2+3+2+9=16, which is a decrease in the number. Here, Cᵢₙ represents an input channel, Cₒᵤₜ represents output channels, M represents a kernel size, and dᵢⱼ represents a Hamming distance between output channel i and output channel j.

In addition, in the computation for the conventional binary neural network, the number of XNOR operations is Hₒᵤₜ×Wₒᵤₜ×Cᵢₙ×M×M, but in the computation for the binary neural network according to the present embodiment, the number of XNOR operations is Hₒᵤₜ×Wₒᵤₜ×(Σ₂^{C}^{ᵢₙ}^{×M×M} dᵢⱼ+Cᵢₙ×M×M). Here, Hₒᵤₜ×Wₒᵤₜ represents a size of an output feature map.

Here, a compression ratio R of the computation for the binary neural network according to an embodiment of the present disclosure compared to the computation for the conventional binary neural network may be expressed by the following Equation 2. The compression ratio may represent a ratio by which the total number of computations for the binary neural network according to an embodiment of the present disclosure is reduced compared to the number of computations for the conventional binary neural network.

$$R = \frac{{\sum }_{j \neq root}^{{C}_{o u t}} {d}_{i j} + {C}_{i n} \times M \times M}{{C}_{out} \times {C}_{i n} \times M \times M} \qquad [ Equation 2 ]$$

Meanwhile, the computing device 12 may train the binary neural network in order to further reduce the depth and total distance of the minimum spanning tree when constructing the fully connected graph for each output channel of the convolutional layer of the binary neural network and extracting the minimum spanning tree (MST) from the fully connected graph.

Specifically, the computing device 12 may cluster weights of each output channel of the convolutional layer of the binary neural network. In this time, various conventional clustering techniques may be used for the clustering. The computing device 12 may randomly select a center from each cluster of the weights. The computing device 12 may train the binary neural network so that the distance between the center of each cluster and respective weights belonging to the cluster is minimized. Here, the overall loss function for the binary neural network may be expressed by the following Equation 3,

$$L = {L}_{0} ( input , {w}_{b} ) + γ {\sum }_{i} {‖ C ( {w}_{b}^{i} ) - {w}_{b}^{i} ‖}^{2} \qquad [ Equation 3 ]$$

L₀ is a loss function according to the original task of the binary neural network,
Y is a pre-set hyperparameter,
C (W_{b}ⁱ) is a center of an i-th cluster, and
W_{b}ⁱ is weights belonging to the i-th cluster.

In the right-hand side of Equation 3, the first part represents the loss function according to the original task of the binary neural network, and the second part represents a loss function for reducing the depth of the minimum spanning tree (MST) and total distance.

According to the disclosed embodiment, by constructing a fully connected graph for each output channel of a convolutional layer of a binary neural network, extracting a minimum spanning tree from the fully connected graph, and re-arranging an order of computations between respective output channels based on the minimum spanning tree, the computational speed in the binary neural network can be increased while reducing the computational cost.

Although representative embodiments of the present disclosure have been described in detail, a person skilled in the art to which the present disclosure pertains will understand that various modifications may be made thereto within the limits that do not depart from the scope of the present disclosure. Therefore, the scope of rights of the present disclosure should not be limited to the described embodiments, but should be defined not only by claims set forth below but also by equivalents to the claims.

1. A computation method for a binary neural network performed on a computing device that includes one or more processors and a memory storing one or more programs executed by the one or more processors, the computation method comprising:
generating a fully connected graph based on output channels of a convolutional layer of a binary neural network;
extracting a minimum spanning tree from the fully connected graph; and
re-arranging an order of computations between respective output channels based on the minimum spanning tree.

2. The computation method of claim 1, wherein the fully connected graph is generated based on a distance between the output channels.

3. The method of claim 2, wherein the output channel includes a list of weights consisting of 0 or 1, and a distance between the output channels is calculated through a Hamming distance.

4. The method of claim 3, wherein the fully connected graph is generated by using each output channel as a node and the Hamming distance between respective output channels as an edge.

5. The method of claim 4, wherein the re-arranging of the order of computations includes performing the computation on an output channel corresponding to a highest node in the minimum spanning tree.

6. The method of claim 5, wherein the re-arranging of the order of computations further includes performing the computation along a lower node having a shorter Hamming distance from the highest node of the minimum spanning tree.

7. The method of claim 6, wherein the computing device uses the following equation to compute a j-th output channel from an i-th output channel,
$${Y}_{j} = 2 ( {P}_{i} - {d}_{i j} + 2 {P}_{ij} ) - {C}_{i n} \times M \times M \qquad [ Equation ]$$
where Pᵢ is a Popcount operation of the i-th output channel,
dᵢⱼ is a Hamming distance between the i-th output channel and the j-th output channel,
Pᵢⱼ is a sum of XNOR operations between the i-th output channel and the j-th output channel,
Cᵢₙ: is an input channel of the binary neural network, and
M is a kernel size.

8. The computation method of claim 1, further comprising:
clustering weights of each output channel of the convolutional layer of the binary neural network;
randomly selecting a center from each cluster in which the weights are clustered; and
training the binary neural network so that the distance between the center of each cluster and each weight belonging to the cluster is minimized.

9. A computing device comprising:
one or more processors;
a memory; and
one or more programs stored in the memory and configured to be executed by the one or more processors, the one or more programs comprising:
an instruction for generating a fully connected graph based on output channels of a convolutional layer of a binary neural network;
an instruction for extracting a minimum spanning tree from the fully connected graph; and
an instruction for re-arranging an order of computations between respective output channels based on the minimum spanning tree.

10. The computing device of claim 9, wherein the fully connected graph is generated based on a distance between the output channels.

11. The computing device of claim 10, wherein the output channel includes a list of weights consisting of 0 or 1, and
the distance between the output channels is calculated through a Hamming distance.

12. The computing device of claim 11, wherein the fully connected graph is generated by using each output channel as a node and the Hamming distance between respective output channels as an edge.

13. The computing device of claim 12, wherein the instruction for re-arranging of the order of computations includes an instruction for performing the computation on an output channel corresponding to a highest node in the minimum spanning tree.

14. The computing device of claim 13, wherein the instruction for re-arranging of the order of computations includes an instruction for performing the computation along a lower node having a shorter Hamming distance from the highest node of the minimum spanning tree.

15. The computing device of claim 14, wherein the one or more programs use the following equation to compute a j-th output channel from an i-th output channel,
$${Y}_{j} = 2 ( {P}_{i} - {d}_{i j} + 2 {P}_{ij} ) - {C}_{i n} \times M \times M \qquad [ Equation ]$$
where Pᵢ is a Popcount operation of the i-th output channel,
dᵢⱼ is a Hamming distance between the i-th output channel and the j-th output channel,
Pᵢⱼ is a sum of XNOR operations between the i-th output channel and the j-th output channel,
Cᵢₙ is an input channel of the binary neural network, and
M is a kernel size.

16. The computing device of claim 9, wherein the one or more programs further include:
an instruction for clustering weights of each output channel of the convolutional layer of the binary neural network;
an instruction for randomly selecting a center from each cluster in which the weights are clustered; and
an instruction for training the binary neural network so that the distance between the center of each cluster and each weight belonging to the cluster is minimized.

17. A computer program stored in a non-transitory computer readable storage medium and including one or more instructions, which, when executed by a computing device including one or more processors, cause the computing device to perform:
generating a fully connected graph based on output channels of a convolutional layer of a binary neural network;
extracting a minimum spanning tree from the fully connected graph; and
re-arranging an order of computations between respective output channels based on the minimum spanning tree.
